(19) United States
(12) Patent Application Publication
(10) Pub. No.: US 2013/0074885 A1
(43) Pub. Date: Mar. 28, 2013

(54) Method and Plant for Treating Bottom Sludge in a Tank

(71) Applicant: IDRABEL ITALIA S.R.L., Arenzano (Genova) (IT)

(72) Inventor: Ivo Saverio Rancich, Cogoleto (Genova) (IT)

(73) Assignee: IDRABEL ITALIA S.R.L., Arenzano (Genova) (IT)

(21) Appl. No.: 13/685,504

(22) Filed: Nov. 26, 2012

Related U.S. Application Data
(62) Division of application No. 12/529,086, filed on Oct. 30, 2009.

(51) Int. Cl. B08B 9/093

(52) U.S. Cl. CPC B08B 9/0933
USPC 134/167 R

(57) ABSTRACT

Method for treating bottom sludge in a storage tank, comprising the step of breaking up the bottom sludge of the tank by the use of one or more jets under pressure. The method is characterized in that it comprises the steps of
monitoring the state of the bottom sludge inside the tank by SONAR means; and
adjusting the action of the jets during the breaking-up step according to the effects on the state of the bottom sludge detected by the monitoring by SONAR means.

The present invention relates to a method and plant for treating bottom sludge in a storage tank.

Advantageously, the method and the plant according to the invention can he used in particular for treating bottom sludge that forms in storage tanks for crude oil or oil products.

### BACKGROUND OF THE INVENTION

As known, tanks for storing liquid state products L must he regularly subject to inspection, cleaning and maintenance operations for preventing the accumulation of sludge F on the bottom, consisting of the heavier solid phases and/or of the liquid phases present in the stored liquids (see FIG. 1). During the storage, in fact, liquids are kept under ideal rest conditions for favouring settling and precipitation of the heavier components.

This problem is especially strong in tanks S for crude oil storage. In fact, crude oil exhibits considerable amounts of solid materials in suspension (sands, rocky debris, metal oxides, coal, etc.) from the extraction sites. Moreover, the heavier hydrocarbon fractions of crude oil (naphthenic compounds and asphalts) naturally tend to aggregate and precipitate.

Bottom sludge F that forms has a very high viscosity and is difficult to be pumped. If regular cleaning and maintenance work is not carried out regularly, considerable deposits therefore form that reduce the useful volume of the tank and due to their irregularity, prevent mobile roofs T of tanks S to correctly rest on the bottom during the steps of partial emptying of the tank.

Conventionally, crude oil storage tanks are therefore provided with blade mixers having the function of keeping the stored liquid mass moving, in particular in the proximity of the bottom, in order to limit as much as possible the sedimentation of heavier parts and therefore the forming of solid or semi-solid sludge.

Mixers are usually associated to heating devices too, having the purpose of keeping crude oil temperature above certain predetermined values especially in the proximity of the bottom, in order to reduce the viscosity of heavier fractions that tend to precipitate, so as to facilitate fluidisation thereof. In fact, 80-90% of the bottom sludge consists of heavy hydrocarbons that at ambient temperature are at the solid state and precipitate in the form of small crystals.

Mixers and heaters, besides operatively being little effective in many cases, are subject to wear and require constant maintenance, to the disadvantage of the full functionality of the tanks. Operating costs arc important too.

Therefore, alternative bottom sludge mixing and fluidisation systems have long been proposed, designed for replacing the conventional systems or for being used in combination therewith.

More in detail, these systems essentially envisage: keeping or returning the bottom sludge suspended by the mechanical action of high pressure jets; fluidising the bottom sludge by a chemical action, dosing emulsifying products; and then subjecting the mixed and fluidised crude oil to filtration so as to reduce the solid contents (sands, oxides) recirculating it in a circuit external to the tank.

A system of this type is described, for example, in U.S. Pat. No. 5,810,473 and envisages the application of rotating guns facing inwards on the external walls of the tank, at the manholes. Each gun is connected to an external circuit provided with pumping means and filtering means. Crude oil and bottom sludge is extracted from the tank, filtered and then recirculated inside the tank through the guns, generating high pressure jets.

Guns are adjustable for allowing the operator to change the jet orientation and range. The gun movement mechanism, however, is constructively complex and requires regular maintenance. This is to the disadvantage of the system reliability.

Systems have been proposed, that besides allowing mixing crude oil and bottom sludge, also envisage subjecting the fluidised and filtered crude oil to suitable treatments for separating heavier hydrocarbon fractions (easily subject to precipitation phenomena and difficult to process) from the aqueous phase and from other fractions of crude oil, using plants external to the tank, which for example comprise centrifuges, settling tanks and/or oil separators.

This system is described for example in U.S. Pat. No. 4,364,776. The system envisages the application of local recirculation circuits to different points of the tank, consisting of a lance and a suction duct connected to one another by a pump. Lances are first fed with water and emulsifying chemical products, generating high pressure jets that serve on the one side for breaking the banks of bottom sludge and on the other side for dispersing the emulsifiers into the bottom sludge itself. After that, the bottom sludge thus fluidised is recirculated into the circuit returning into the tank, sprayed at high pressure through the lances, thus contributing to the mixing of the bottom sludge and of crude oil. Operatively, the lances may be moved between predetermined fixed positions, so as to allow the operator to hit the bottom sludge banks from different angles. The profile and the shape of the bottom sludge are determined in advance at the beginning of the operations carrying out surveys through openings obtained on the mobile cover of the tank.

A first common limit to both systems described above consists in the fact that it is not possible to check the effects of the jets on the bottom sludge in real time. It is therefore substantially impossible to optimise the action of the jets themselves, both in terms of orientation and of duration.

A second limit common to the systems described above consists in the fact that the installation of the devices required for mixing (guns, lances) can take place by first emptying the tank (and therefore temporarily putting the tank out of service) as in the case of the system described in U.S. Pat. No. 5,810,473, or without emptying the tank, but with the risk of crude oil losses and with complex and difficult procedures, as in the case of the system described in U.S. Pat. No. 4,364,776.

Moreover, it is noted that the system described in U.S. Pat. No. 4,364,776, despite allowing tank cleaning, is operatively little flexible as it is conditioned by the availability and operating capacity of the plants used for separating the different phases of crude oil. In fact, given the amounts of crude oil to he treated that are normally involved, either fixed separation plants of suitable capacity are available on site, or mobile plants must be used, which unavoidably have a limited capacity, with consequent extension of the treatment times.

### SUMMARY OF THE INVENTION

The object of the present invention is to provide a method for treating bottom sludge in a storage tank which should allow making the sludge bank breaking-up operations more effective as compared to conventional systems.

A further object of the present invention is to provide a method for treating bottom sludge in a storage tank which should allow separately recovering the different phases of the bottom sludge without requiring treatment operations on the bottom sludge outside the tank.

A further object of this invention is to provide a plant for treating bottom sludge in a storage tank which should allow using the means intended to breaking up the bottom sludge banks in a more effective manner.

A further object of this invention is to provide a plant for treating bottom sludge in a storage tank which should be constructively simple and operatively reliable, in particular as regards the means for generating jets under pressure.

A further object of the present invention is to provide a plant for treating bottom sludge in a storage tank which should allow being installed in a tank without requiring the emptying thereof or in any case reducing the risk of fluid losses or leaks.

Such objects are achieved by the method and the plant for treating bottom sludge in a storage tank as described in the following claims.

### BRIEF DESCRIPTION OF THE DRAWINGS

Further features and advantages of the method and plant according to the invention will appear more clearly from the following description of some preferred embodiments thereof, made by way of a non-limiting example with reference to the annexed figures, wherein:

FIG. 1 shows a storage tank with bottom sludge banks on the bottom;

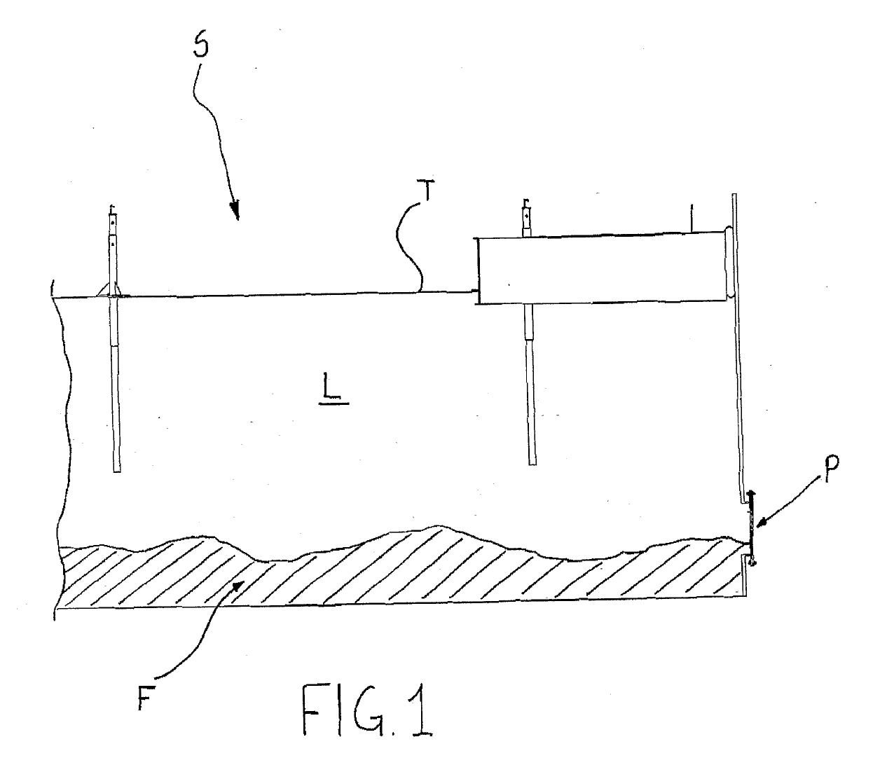

FIGS. 2 and 3 show two section respectively side and plan views, of a plant for treating bottom sludge according to a preferred solution of the invention;

FIGS. 4 and 5 show a preferred solution of installation of the plant according to the invention in a storage tank;

FIG. 6 shows the plant according to a preferred embodiment of the invention in a step of collection of the hydrocarbon phase separated inside a storage tank;

FIG. 7 shows the plant according to a preferred embodiment of the invention in a step of collection of the aqueous phase separated inside a storage tank;

FIG. 8 shows the plant according to a preferred embodiment of the invention in a step of degassing of a tank cleaned from the bottom sludge;

FIGS. 9 and 10 show two respectively side and plan views, of a gun for generating jets under pressure according to a preferred embodiment of the invention;

FIG. 11 shows a plan view of the gun shown in FIGS. 9 and 10 connected to a delivery hose of pumping means;

FIG. 12 shows a side section view of the gun shown in FIG. 11 arranged inside a containment body;

FIG. 13 shows a section view of the gun and of the relative containment body arranged inside a coupling body;

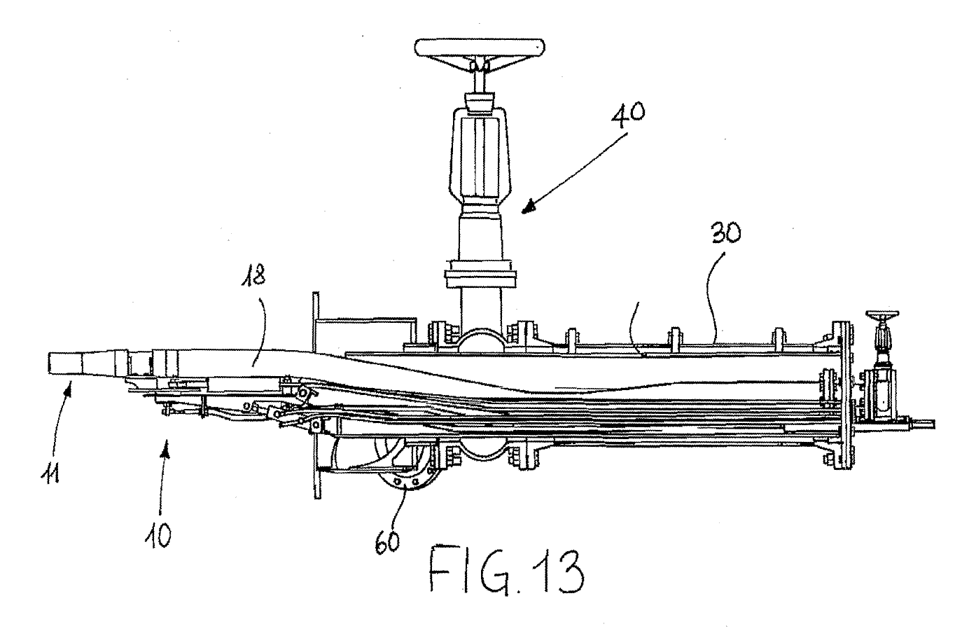

FIG. 14 shows a front view of a tubular element o he connected to a manhole;

FIGS. 15 and 16 show the tubular element shown in FIG. 14 connected to the manhole of a tank, respectively in two section views, respectively side and plan;

FIGS. 17 to 20 show four assembly steps of the plant according to a preferred embodiment of the invention in a tank; and

FIG. 21 shows an enlarged section view of the detail highlighted with a circle in FIG. 20 and relating to the sealed connection between the containment body of the gun shown in FIG. 12 and the coupling body.

### DETAILED DESCRIPTION OF THE PREFERRED EMBODIMENTS

The method for treating bottom sludge F in a storage tank S according to the present invention envisages the breaking-up of the bottom sludge using one or more jets G under pressure.

The method is characterised in that the breaking-up operations of the bottom sludge banks F are made more effective by monitoring the state of the bottom sludge inside a tank by SONAR means (not shown in the annexed figures) and adjusting the action of jets G according to the effects detected on bottom sludge F.

The sonar is a distance measuring technology based on sound propagation speed in different media, gaseous, liquid and solid.

In the preferred field of application of the invention the media is in liquid form and has a hydrocarbon base with density variable between 700 Kg/m³ and 1000 Kg/m³. The media density however, does not represent a hindrance, since it is possible to adapt the system to the type of media, suitably calibrating the sonar frequency and power.

The operating principle of the SONAR is based on the time elapsing between the moment a sound pulse is emitted and the listening of the return echo on the same point compared to the typical speed of propagation in the media. The sound reflection degree furthermore, gives an estimate of the consistency of the reflecting object.

Advantageously, thanks to the SONAR monitoring it is therefore possible to determine the shape of bottom sludge banks F. As mentioned hereinabove, the SONAR means in fact allow evaluating the distances existing between the bottom sludge banks and the devices used for generating jets under pressure. By determining the bottom sludge position it is therefore possible to suitably adjust the orientation and the range of the jets themselves.

Moreover, the SONAR means allow evaluating the consistency of bottom sludge banks based on the sound reflection degree. Based on the consistency of the bottom sludge found it is therefore possible to adjust the jet pressure and the treatment times for obtaining a complete breaking-up.

Advantageously, the SONAR means further allow determining the presence of metal bodies inside the tank, such as pipes, mixers or heating devices.

Based on the sound reflection degree of these objects (influenced by the presence of scale or bottom sludge deposits) it is possible to evaluate the cleaning level thereof. Operatively, once the desired cleaning level has been reached, it is possible to guide the jets so as to avoid such objects that now are clean.

Thanks to the method according to the invention described above it is therefore possible to optimise the use of the means used for generating jets under pressure in the breaking-up of bottom sludge. With the same treatment times it is therefore possible to obtain better results in terms of breaking-up of the bottom sludge and tank cleaning; whereas, with the same results it is possible to considerably reduce the treatment times.

Advantageously, the method according to the invention envisages the possibility of determining the state of the bottom sludge F before starting the cleaning or cleaning operations. In this way, knowing the amounts of bottom sludge and their shape it is possible to evaluate the need of a cleaning treatment or optionally, to schedule it.

According to the invention, a system for mapping the interior of a storage system comprises:
active SONAR means suitable for detecting the state of the bottom sludge inside the tank and the presence of any metal bodies, and
at least one data processing unit connected to the SONAR means.

The processing unit is suitable for displaying the interior of the tank or, in combination with or as an alternative to, for interfacing with bottom sludge treatment plants.

Operatively, the SONAR means comprise at least two sound transducers arranged into the tank for carrying out triangulations.

Advantageously, the sound transducers used are adjustable for allowing the scan of the entire tank.

The term “transducers” means devices capable of emitting and receiving sounds, which is the function carried out by an active SONAR.

The structure of a SONAR device is not described herein, as it is known to a man skilled in the art.

An object of the method according to the present invention it to separately recover the different phases of the bottom sludge in a tank for storing crude oil or other oil products.

To this end, the method for treating bottom sludge according to the invention comprises the steps of;
fluidising the bottom sludge by mixing by the action of jets under pressure;
dispersing biosurfactants based on rhamnolipids RLL and/or rhamnolipids RRLL in the bottom sludge;
settling the contents of the tank thus treated interrupting the mixing, so as to allow the precipitation of inorganic sediments D and the separation of the aqueous phase A from the hydrocarbon phase;
separately extracting the hydrocarbon phase, the aqueous phase A and sediments D from the tank.

Advantageously, a degassing step may be envisaged, subsequent to the extraction of the aqueous phase A and prior to the extraction of the solid sediments D on the bottom (sands, asphaltenes, resins, etc.).

Rhamnolipid RLL is the compound (α-L-rhamnopyranosyl-α-L-rhamnopyranosyl-β-hydroxydecanoil-β-hydroxydecanoate), whereas rhamnolipid RRLL is the compound (2-O-α-L-rhamnopyranosyl-α-L-rhamnopyranosyl-β-hydroxydecanoil-β-hydroxydecanoate).

More in detail, the biosurfactants used are of microbial origin, and besides the rhamnolipids mentioned above, formed during the controlled fermentation process, they contain glycolipids, surface-active agents and biological emulsifiers.

These biosurfactants are capable of emulsifying heavier hydrocarbon fractions in the bottom sludge, reducing the viscosity thereof and the tendency to precipitate.

Thanks to the action of these biosurfactants, during the settling step subsequent to the fluidisation by mixing the hydrocarbon phases remain in suspension, actually letting only the inorganic solids (sands, oxides) and the solid non-emulsifiable hydrocarbon phases (resins, lakes, asphaltenes, charcoal) precipitate. The settling further allows separating the hydrocarbon phase from the aqueous phase.

Operatively, it is therefore possible to separately take the various phases directly from the tanks. The aqueous phase, substantially free from hydrocarbons, can be disposed of more easily, whereas the hydrocarbon phase, freed from solid sediments and from water, can be subject to the normal refining processes at lower costs.

In this way, the treatments for separating the aqueous phase from the hydrocarbon phase which would otherwise be necessary, are avoided after the cleaning operations, while reducing the amounts of non-processable sludge D to be disposed of.

Preferably, the method according to the invention envisages a sampling step for determining the amount and the average composition of the bottom sludge. Based on these data it is possible to calculate the dose of biosurfactants to be dispersed in the bottom sludge.

Preferably, biosurfactants B are dispersed in bottom sludge F using the jets G under pressure and their mechanical mixing action.

Preferably, the two methods according to the invention described above are combined together for obtaining a synergic effect. However, it is possible to apply them separately, too.

According to the invention, the plant (indicated with reference numeral 1 in the annexed figures) for treating bottom sludge F in a storage tank S comprises means 10 for generating one or more jets G under pressure inside tank S for breaking up the banks of bottom sludge F and/or mixing contents F+L of the tank.

Such means 10 for generating jets are fed with fluid taken from the storage tank and are subject to being adjusted so as to vary the range and the direction of the jets generated thereby.

The plant further comprises a unit for controlling the above means for generating jets, operating according to predetermined control logics.

The plant is characterised in that it comprises active SONAR means suitable for detecting the state of the bottom sludge inside the tank.

Operatively the SONAR means interface with the above control unit so as to allow the latter to adjust the range and the orientation of the jets according to the state of the bottom sludge.

Advantageously, it is possible to provide the control unit with a system for self-learning the best rules applicable for the breaking-up of the bottom sludge banks, for example using neural networks, fuzzy logic or statistical systems for determining the result in relation to the action executed.

This allows using the means available for generating jets in a more effective manner provided that they allow adjusting the orientation and the range of the jet.

As already mentioned before. SONAR means are not described herein as they are known to a man skilled in the art. Reference is only made to the fact that such means must be provided with sound transducers (not shown in the annexed figures), meaning with this term devices capable of emitting and receiving sound waves.

While sound transducers may be arranged in any position inside the tank, they are preferably associated to the means for generating jets in such a way as to act as “sights” for the control unit.

Preferably, given the distances involved in crude oil storage tanks (10 m to 150 m, intended as diameter or longest side of the tanks), sound transducers are of the variable frequency type.

Advantageously, in the case of use of hydrocarbon products in the tanks, the frequency may be in the range comprised between about 7.5 kHz and about 200 kHz.

Preferably, the transducers are of the variable power type.

Advantageously, in the case of use of hydrocarbon products in the tanks, the power may be in the range comprised between about 50 W RMS and about 250 W RMS.

Advantageously, to prevent explosions, the transducers are connected outside the tank for feeding and transmitting measurement and control signals or by electrical cables in sealed raceways, or by optical fibres visible or laser light.

Advantageously, in the plant described hereinabove it is possible to use any type of device for generating jets under pressure, provided that they allow adjusting, at least the orientation and the range of the jets generated thereby.

Preferably, the plant according to the invention is provided with means for generating jets comprising one or more guns 10 provided with nozzles 11.

In particular, the means for generating jets may be of the type described hereinafter in the description.

Operatively, the guns usable in the plant according to the invention are fed with fluid taken from the tank by pumping means 20, such as a centrifugal pump. It is also possible to use a branch of the tank supply line as pumping means.

In accordance with a preferred embodiment not illustrated herein, the nozzle is of the type with adjustable outlet section.

Advantageously, this solution imparts higher flexibility to the plant, because increasing or decreasing the nozzle outlet section it is possible to switch from a dot-like action to a more diffused one.

Operatively, the nozzle opening and closing system is managed by the control unit based on the data sent by the SONAR means according to the predetermined control logic.

As already mentioned, a further object of this invention is to provide a plant for treating bottom sludge in a storage tank which should he constructively simple and operatively reliable, in particular as regards the means for generating jets under pressure.

This object is achieved by a plant for treating the bottom sludge in a storage tank, in particular for crude oil and oil products, comprising one or more guns 10 suitable for generating jets G under pressure inside tank S for breaking up the banks of bottom sludge and/or mixing the contents of said tank.

Preferably each gun 10 is provided with an adjustable nozzle 11 for varying the range and the direction of said jets and is fed with fluid taken from tank S by pumping means 20.

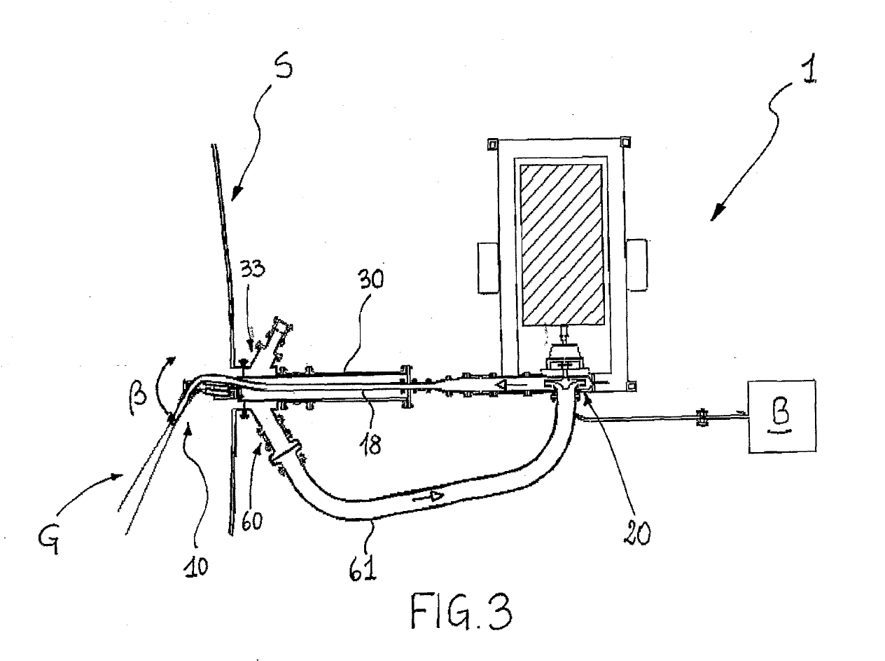

In accordance with a preferred installation solution illustrated in FIGS. 4 and 5, a series of guns is installed, distributed at regular distances along the external development of tank S.

Operatively, it is possible to orientate the guns and the relative nozzles so as to impart complete rotations to all the liquid mass contained in the tank (see FIG. 5) or impart local circulations in sectors (see FIG. 4).

According to the invention, each gun comprises a support structure 12 that can be inserted through an opening P obtained in the walls of tank S and provided with a mobile head appendix 13 suitable for supporting nozzle 11.

More in detail, the mobile appendix 13 consists of:
an arm 14 pivoting relative to the support structure 12; and
a turntable 15 that is connected to the free end 14′ of the pivoting arm 14 and that carries nozzles 11 fixed thereto.

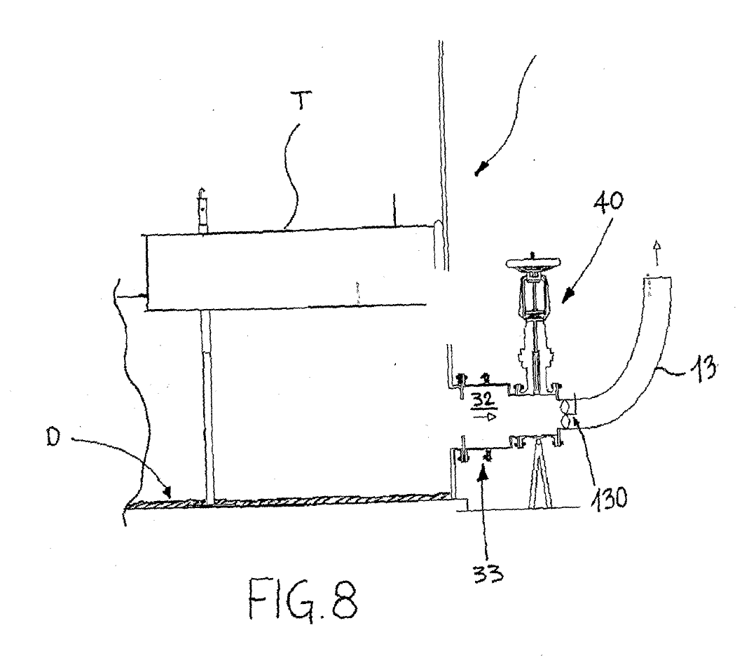

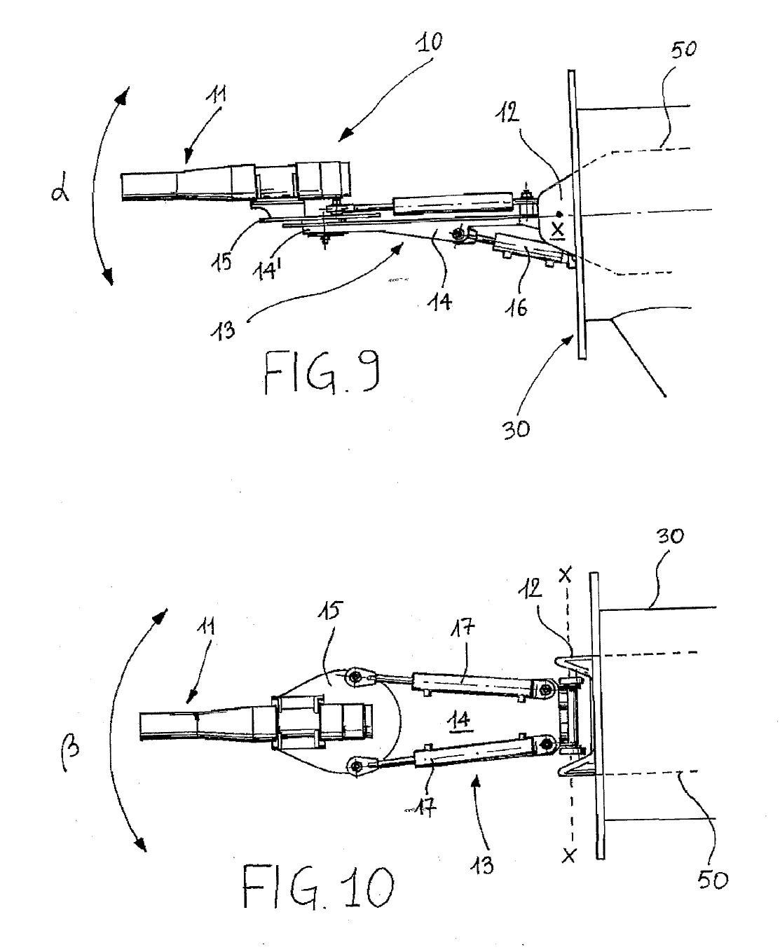

As can be seen in particular in FIGS. 9, 10 and 11, gun 10 further comprises at least a first linear actuator 16, which acts between the pivoting arm 14 and the support structure 12 for varying the rising angle u of nozzle 11, and at least a second linear actuator 17, which acts between the pivoting arm 14 and turntable 15 for varying the rotation angle β of nozzle 11.

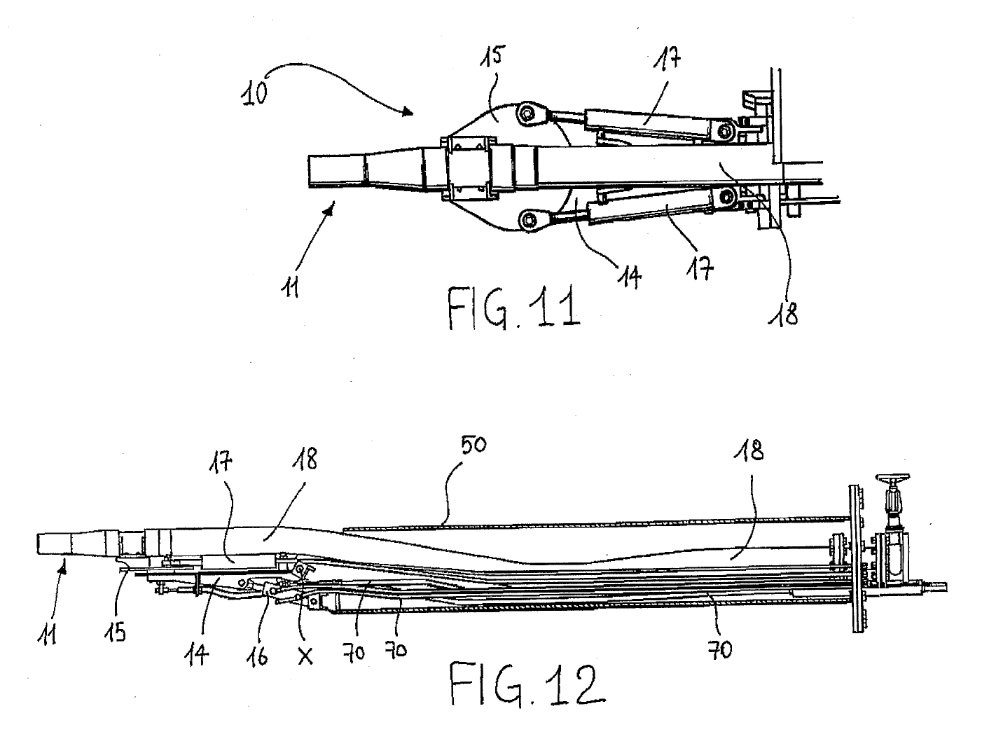

Preferably, linear actuators 16, 17 consist of oil-pressure pistons. Reference numeral 70 in FIG. 12 indicates the oil-pressure system feeding pipes.

Preferably, as illustrated in the annexed figures, the linear actuators 16, 17 work in pairs.

Operatively, each linear actuator 16, 17 can be managed by the above control unit according to the data sent by the SONAR means according to the predetermined control logic.

Preferably, each nozzle 11 is connected to the pumping means 20 by a hose 18 to leave freedom of movement to nozzle 11.

Operatively, compared to solutions with stiff delivery pipes, optionally defining paths with sharp bends, adopting a flexible delivery hose it is possible to reduce load losses.

Advantageously, to this end, the hose is internally coated with a smooth film suitable for reducing the roughness thereof.

Advantageously, the plant according to the invention comprises, for each gun, a tubular coupling body 30 connectable to an opening P obtained on the walls of tank S, for example at a manhole P. The assembly of plant 1 shall be described hereinafter.

The above coupling body 30 is provided with valve means 40 suitable for defining two chambers 31 and 32 therein: a first chamber 31 is intended for communicating with the tank exterior; and a second chamber 32 is intended for communicating with the tank S interior.

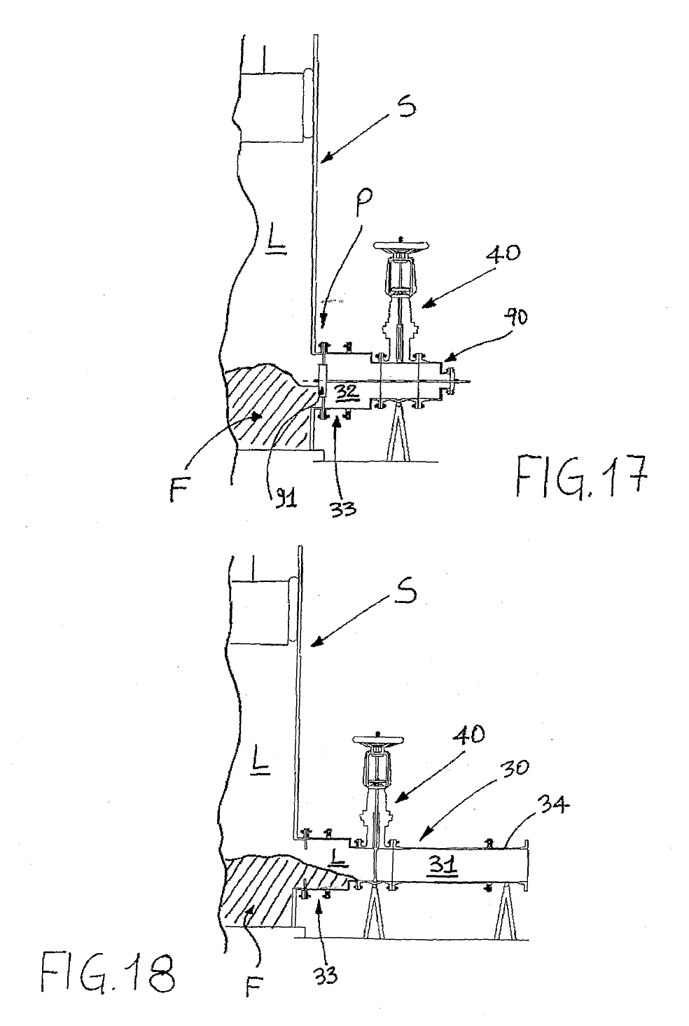

Preferably, as can be seen in FIGS. 15 and 18, the coupling body consists of two different flanged tubular portions connected to one another by valve means 40. A first tubular portion 33 forms the second chamber 32 and is intended for being mounted on the manhole. The second tubular portion 34 defines the first chamber 31 and is connected to the valve means 40 mounted in advance on the first tubular portion 33.

Advantageously, each gun 10 comprises a containment body 50 that can be telescopically inserted sealed in the above coupling body 30, and in particular in the second tubular portion 34.

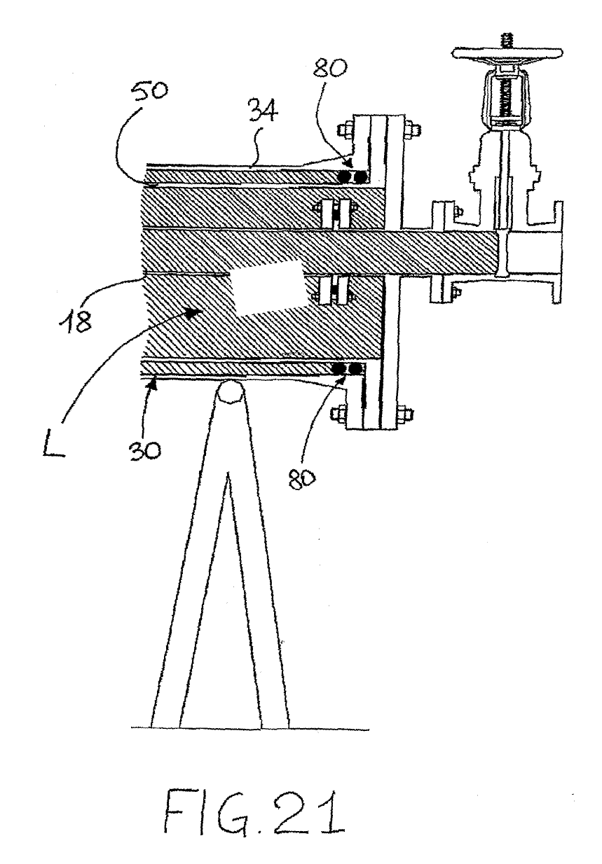

FIG. 21 shows a detail of the telescopic coupling between the containment body 50 and the coupling body 30. In particular, the hermetic seal between the two bodies is ensured by seals 80 seated outside inlet 34′ of the second tubular portion 34.

Operatively, the nozzle switches from a coupling position shown in FIG. 19, wherein the nozzle is arranged in the first chamber 31, to an insertion position shown in FIG. 20, wherein the nozzle is arranged inside the tank after having crossed the second chamber 32.

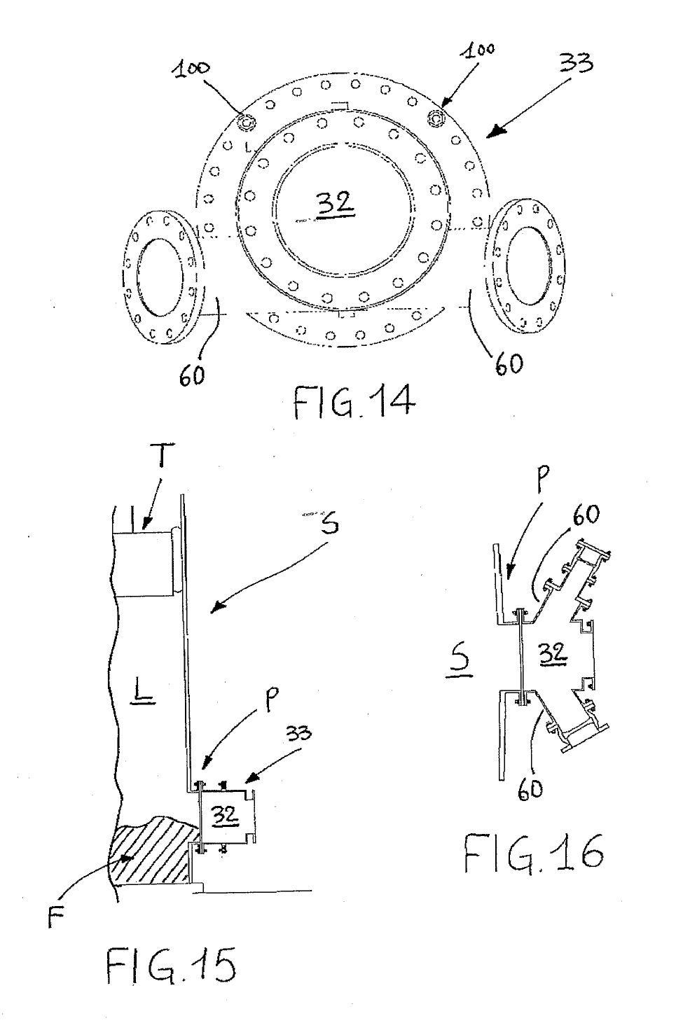

Advantageously, as can be seen in particular in FIGS. 3, 14 and 16 the above coupling body 30 exhibits at least one union 60 for a branch obtained at the first tubular portion thereof 33.

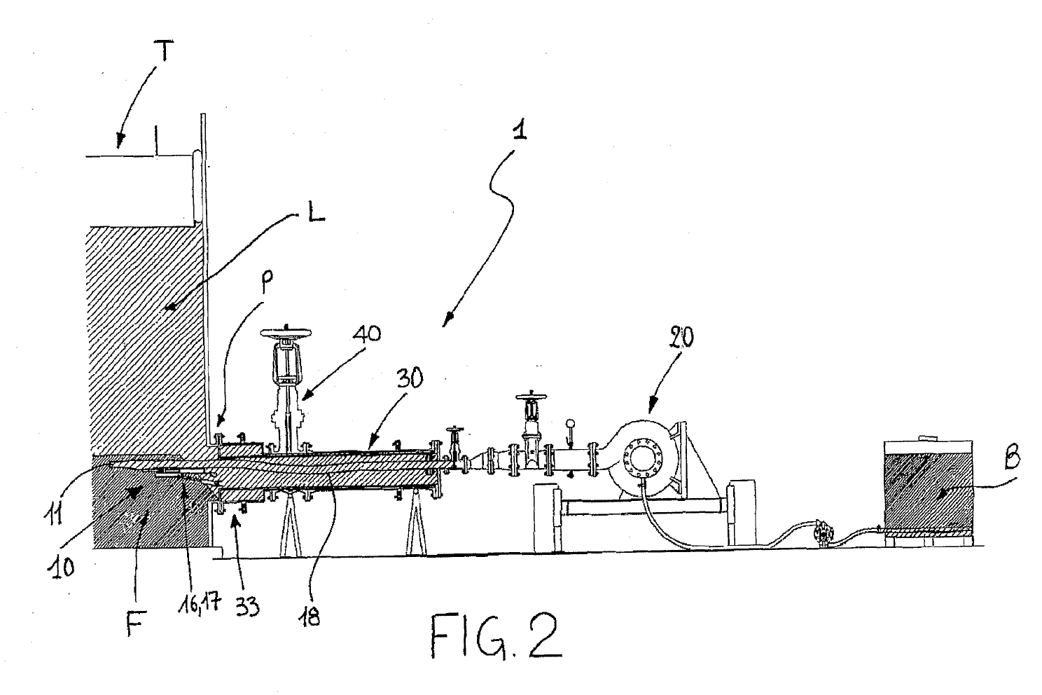

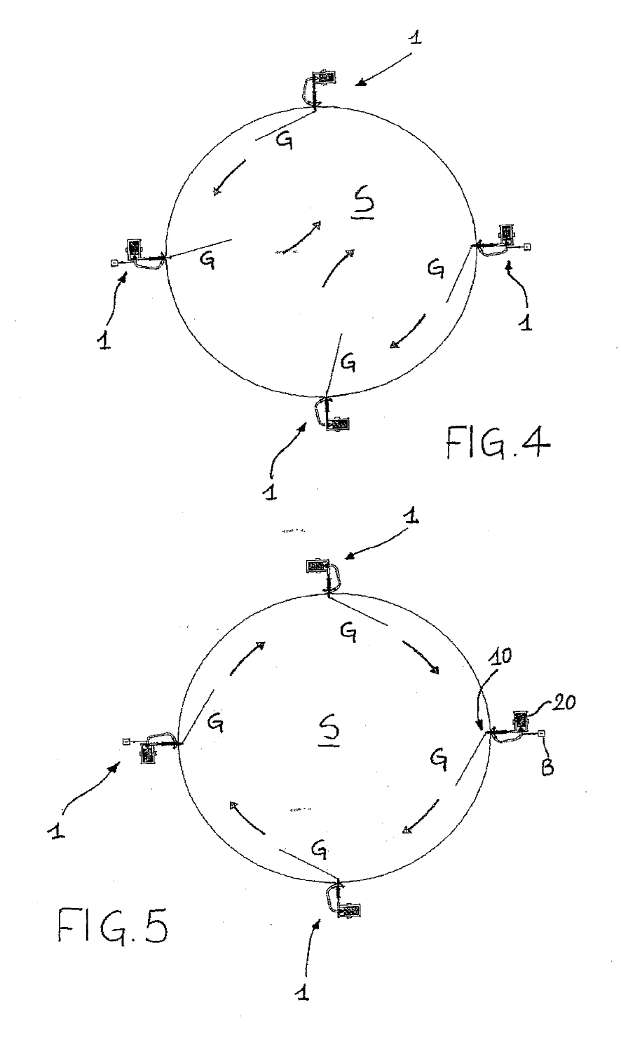

Preferably, as can be seen in FIGS. 2 and 6, the coupling body 30 exhibits an increased section at said first tubular portion 33, that is, preferably at the second chamber 32 that communicates with the interior of the tank. Such increased section allows the flow of the fluid contained in the tank during the suction of the tank contents by the pumping means 20.

Advantageously, the coupling body 30 is connected to the above pumping means 20 by a duct 61 connected to union 60.

Operatively, the coupling body 30 therefore also acts as suction duct for the fluid contained in the tank, at least at the first tubular portion 33 thereof.

Preferably but riot necessarily, the plant according to the invention just described comprises active SONAR means suitable for detecting the state of the bottom sludge inside the tank.

Operatively, according to what already described above, the SONAR means interface with a control unit of the means for generating jets so as to allow the latter to control said linear actuators 16, 17 adjusting the rising angle and the rotation angle of the nozzle according to the state of the bottom sludge.

Preferably, the sound transducers of the SONAR means are associated to the nozzles.

The steps for assembling a plant 1 according to the invention in a tank S shall now be briefly described for showing how plant 1 according to the invention may be mounted on tanks with liquid level higher than the manhole.

The main operating steps shall also be illustrated.

With reference to FIGS. 15 and 16 the first tubular portion 33 of the coupling body is first mounted at a manhole P. Operatively, all the bolts of the manhole flange are removed except for four for allowing the flange to remain fixed in position. The second portion 33 is provided with a flange with through holes at those of the blind flange. In particular four holes obtained at 90° exhibit a larger section for receiving the residual bolts of the blind flange.

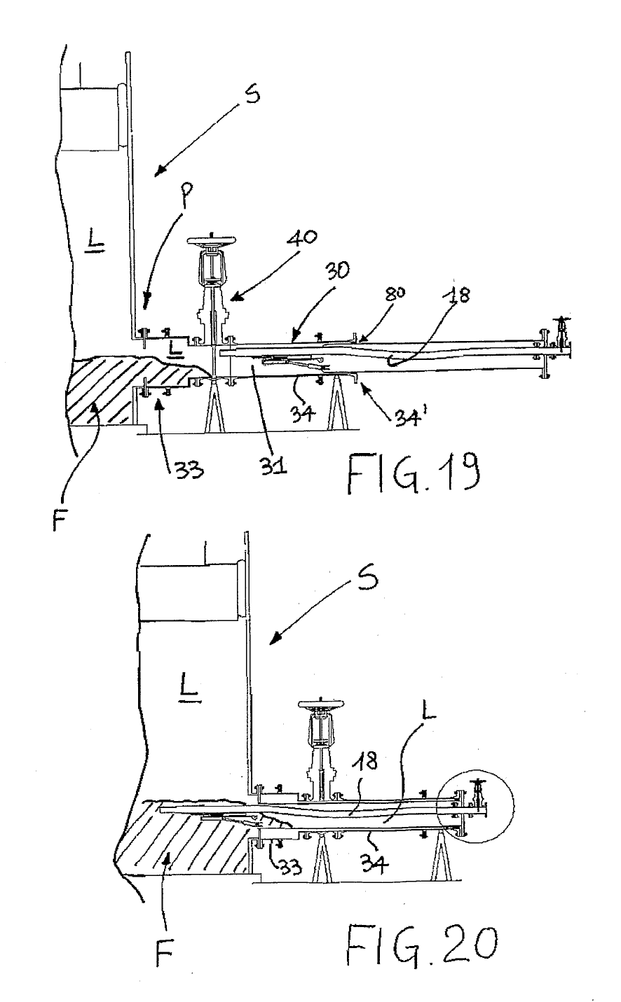

With reference to FIG. 17 a 16″ valve is connected to the first tubular portion 33 and then a pipe drilling machine 90 is connected to the valve, to cut the blind flange. The valve is closed and the pipe drilling machine is disconnected.

At that point, as can be seen in FIG. 18, the closed valve 40 is connected to the second tubular portion 34 of the coupling body 30.

Then, as shown in FIG. 19, gun 10 with nozzle 11 at the head thereof is inserted in the second tubular portion 34. The containment body 50 of the gun seals with the coupling body 30 thanks to seals 80 (O-rings).

At that point it is possible to open valve 40 and let gun 40 into tank S thus placing it into position. The containment body 50 is provided with a flange at the end opposite the nozzle which abuts on the coupling body and is fixed thereto.

At that point, as shown in FIG. 3, the pumping means 20 are connected to union 60 by pipe 61 and the tank content recirculation starts with the generation of jets under pressure thanks to gun 10.

During this step of fluidisation and breaking-up of the bottom sludge (guided by the SONAR means and by the control unit) also the biosurfactants contained in a tank B that is connected in suction to the pumping means 20, are dosed.

The fluidisation step is followed by the settling step during which solid sediments precipitate, the aqueous phase is separated from the hydrocarbon phase, which had been emulsified by the biosurfactants. The hydrocarbon phase is above the aqueous phase.

At the end of the settling step as shown in FIG. 6, it is therefore possible to extract the hydrocarbon phase using duct 61. The pumping means 20 are not connected to the hose of gun 10 anymore, but to a duct for delivering the recovered hydrocarbons to refining or to another storage tank.

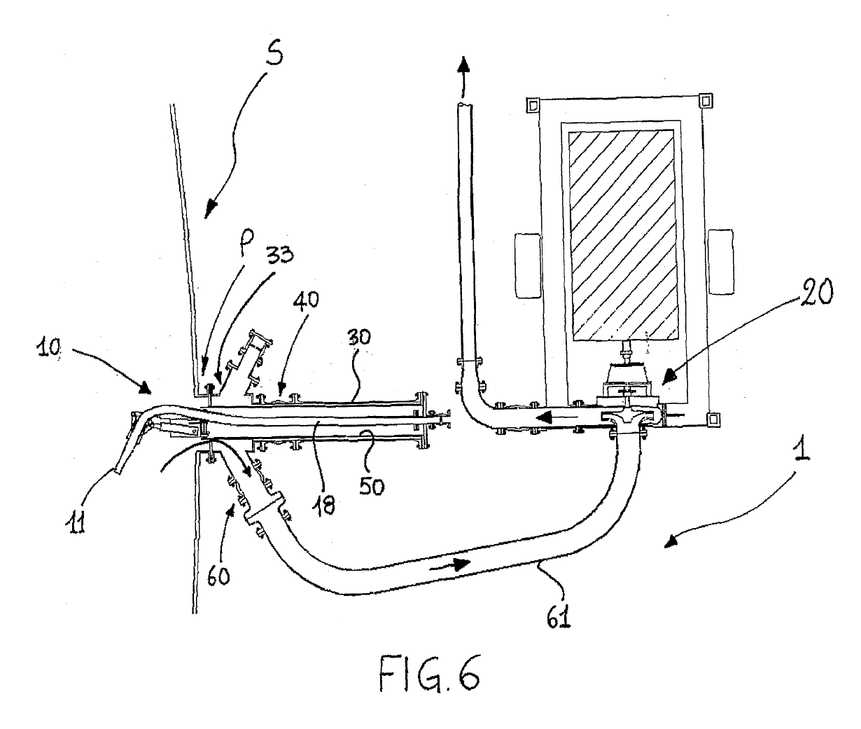

Once the hydrocarbon phase has been eliminated, the aqueous phase is taken by other pumping means 121 or by drainage, as shown in FIG. 7.

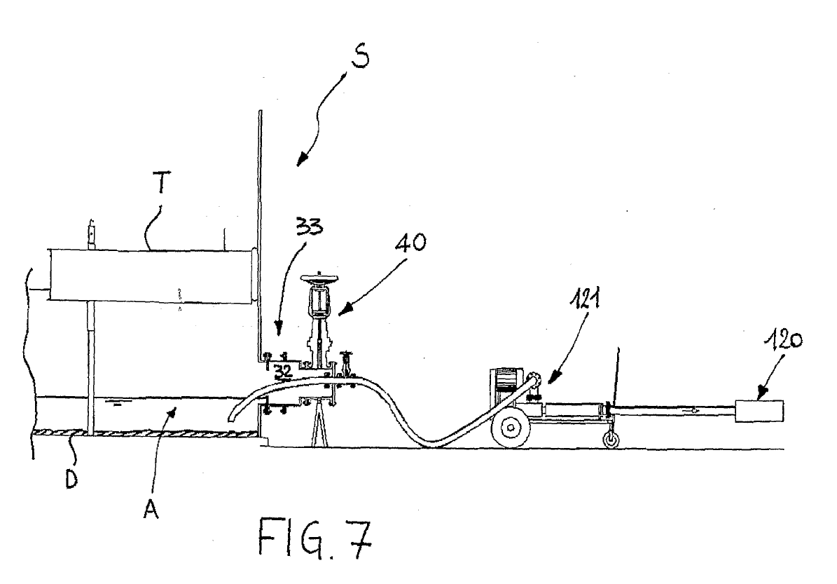

At that point before removing solid sediments, a tank degassing is carried out, connecting a duct 131 provided with a fan 130, as shown in FIG. 8.

Advantageously, dosing biosurfactants B decreases the viscosity of the recirculated fluid thus reducing also load losses in the recirculation circuit.

The invention thus conceived thus achieves the intended purposes.

Of course, in the practical embodiment thereof, it may take shapes and configurations differing from that illustrated above without departing from the present scope of protection.

Moreover, all the parts may be replaced by technically equivalent ones and the sizes, shapes and materials used may be whatever according to the requirements.

1-61. (canceled)

62. Plant for treating bottom sludge in a storage tank, comprising:
means for generating one or more jets under pressure into the tank, said jets serving for breaking up the banks of bottom sludge and/or for mixing the contents of said tank, said means being adjustable for varying the range and direction of said jets and being intended for being fed with the contents of said tank; and
a control unit of said means for generating jets;
characterised in that it comprises active SONAR means suitable for detecting the state of the bottom sludge inside said tank, said SONAR means interfacing with said control unit so as to allow the latter to adjust the range and the orientation of said jets on the basis of the bottom sludge state.

63. Plant according to claim 62, wherein the sound transducers of said SONAR means are associated to said means for generating jets.

64. Plant according to claim 63, wherein said sound transducers use a variable frequency.

65. Plant according to claim 64, wherein said frequency is variable within the range comprised between 7.5 kHz and 200 kHz.

66. Plant according to claim 63, wherein said sound transducers use a variable power.

67. Plant according to claim 66, wherein said power is variable within the range comprised between 50 W RMS and 250 W RMS.

68. Plant according to claim 63, wherein said sound transducers are arranged inside said tank.

69. Plant according to claim 63, wherein said transducers are connected to the exterior of the tank by electrical cables in sealed raceways.

70. Plant according to claim 63, wherein said transducers are connected to the exterior of the tank by laser or visible light optical fibres.

71. Plant according to claim 62, wherein said means for generating jets comprise one or more guns provided with nozzles.

72. Plant according to claim 62, wherein said guns are fed with fluid taken from said tank by pumping means.

73. Plant according to claim 71, wherein each gun comprises a support structure that can be inserted through an opening obtained in the walls of said tank, said structure being provided with a mobile head appendix that supports said nozzle, said mobile appendix consisting of:
an arm pivoting relative to said support structure; and
a turntable connected to the free end of said pivoting arm, said nozzle being fixed to said turntable.

74. Plant according to claim 73, wherein each gun further comprises:
at least a first linear actuator acting between said pivoting arm and said support structure for varying the rising angle of said nozzle;
at least a second linear actuator acting between said pivoting arm and said turntable for varying the rotation angle of said nozzle.

75. Plant according to claim 74, wherein said linear actuators are oil-pressure pistons.

76. Plant according to claim 75, wherein each piston is managed by said control unit.

77. Plant according to claim 72, wherein said nozzle is connected to said pumping means by a hose.

78. Plant according to claim 77, wherein said hose is internally coated with a smooth film suitable for reducing the roughness thereof.

79. Plant according to claim 71, wherein said nozzle has an adjustably outlet section.

80. A system for treating bottom sludge in a storage tank, comprising:
one or more guns configured to generate one or more jets under pressure into a storage tank, each gun having an adjustable nozzle for varying a range and a direction of the one or more jets, each jet being generated from fluid from the storage tank;
a detection system configured to detect the state of a bottom sludge in the storage tank; and
a control system in electrical communication with the detection system, the control system configured to adjust at least one adjustable nozzle based, at least in part, on the bottom sludge.

81. The system of claim 80, further comprising:
a pumping means configured to pump the fluid from the storage tank to the one or more guns to generate the one or more jets.
